(19) United States
(12) Patent Application Publication
(10) Pub. No.: US 2004/0221009 A1
(43) Pub. Date: Nov. 4, 2004

(54) Keyboard-video-mouse (KVM) loop back configuration for virtual presence architecture (VPA)

(75) Inventors: Colin N.B. Cook, Riverton, UT (US); Warren K. Unice, Sandy, UT (US)

Correspondence Address: Davidson Berquist, Klima & jackson LLP, Suite 920, 4501 North Fairfax Drive, Arlington, VA, 22203, US

(73) Assignee: Soronti, Inc.

(21) Appl. No.: 10/792,285

(22) Filed: Mar. 4, 2004

Related U.S. Application Data
(60) Provisional application No. 60/452,175, filed on Mar. 4, 2003.

(51) Int. Cl. G06F 15/16

(52) U.S. Cl. 709/203

(57) ABSTRACT

A method and system is disclosed for incorporating a virtual presence server on a host computer. Video signals generated by a host computer are transmitted to a client using the virtual presence server in order to allow the user of a client computer to have a virtual presence on the host computer. However, the virtual presence server should not interfere with the main functions and operations of the host computer. Therefore this virtual presence server uses a stand alone device, such as a PCI card, as the virtual presence server in order to retain independent functionality from the host computer and occupy minimal physical space and power.

This application claims priority of U.S. Provisional Patent Application Serial No. 60/452,175 filed Mar. 4, 2003, which is hereby fully incorporated by reference.

### FIELD OF THE INVENTION

This invention generally relates to the field of remote computer access. More specifically, an embodiment of the present invention relates to virtual presence architectures.

### BACKGROUND OF THE INVENTION

It is often the case that a host computer is located physically distant from its operator. Some products have been created to facilitate remote control of a computer using devices that remotely project the keyboard, video and mouse. These are typically called keyboard-video-mouse (KVM) devices. Examples include:

1. KVM Switch: Enables a single keyboard, mouse and video display to be shared by multiple computers;

2. KVM remote: Enables a keyboard, mouse and video display to be viewed remotely, with typically several hundred feet of separation;

3. Remote Control Software: Enables a computer to “take over” a remote computer and use the local machine to provide keyboard and mouse input, and video output over a network; and

4. Specialized hardware components that interact with proprietary software to provide remote KVM functionality over a network.

However each of these approaches has disadvantages. For example, software configuration of the host is one of the most difficult, in part, because it may differ significantly from machine to machine, depending on the installed software and hardware. Also, anytime hardware is added, other issues are introduced such as the need for platform certification, new drivers and the like. Consequently there is a need for a KVM device that can work with a host computer without impacting the functionality of the host computer. Additional benefits can be derived by making the KVM device easily installed on the host computer.

KVM device solutions have used a variety of methods to integrate VPS-style architectures into host computers. Typically, these methods include adding hardware to the host computer that is intrusive and affects the computer's performance. One such method adds a PCI card to the host computer to watch the frame buffer (known as “snooping”). Another would use the PCI card in the bus to read the buffer (also known as “scraping”). Still another method makes the PCI card a remoting system with a video graphics chip on the card. Also, other solutions route the video frame data through a virtual presence server that is outside of the host computer. These methods can be expensive and difficult to set up. They can also slow down the data transmission rate.

### BRIEF SUMMARY OF THE INVENTION

The present invention, which may be implemented utilizing a general-purpose digital computer, in certain embodiments of the present invention, includes novel methods and apparatus to provide efficient, effective, and/or flexible ability to use existing local area network (LAN) infrastructure for remote control of host computers without requiring significant reconfiguration of their software and/or hardware.

One embodiment of the present invention includes an architecture that provides remote control of a host computer over existing internet protocol (IP) network infrastructure without requiring significant changes to the remote host, but allows deployment with different levels of intrusiveness (e.g., depending on the requirements of the application).

In another embodiment of the invention, the implementation of the architecture requires no software changes to the remote host. In another embodiment of the present invention, a separate device with its own power and case is utilized (e.g., a stand-alone device).

In yet another embodiment of the present invention, a peripheral component interconnect (PCI) card is utilized which uses a personal computer (PC) as a case and power supply, but does not otherwise interact with the PC hardware except through the external keyboard, mouse and video display connections.

In a different embodiment of the present invention, each of these implementations may interact with software on a remote computer to provide keyboard, video and mouse access. It will also be possible to provide remote access to other devices such as cameras, printers and the like (e.g., utilizing the universal serial bus (USB) standard) from the local computer.

### BRIEF DESCRIPTION OF THE DRAWINGS

FIG. 1 is a block diagram of an exemplary system into which virtual presence architecture may be implemented.

FIG. 2 is an exemplary block diagram of a virtual presence architecture.

FIG. 3 is a more detailed block diagram of a virtual presence architecture.

FIG. 4 illustrates an exemplary flow for the VPS and VPC video subsystems.

### DETAILED DESCRIPTION OF THE INVENTION

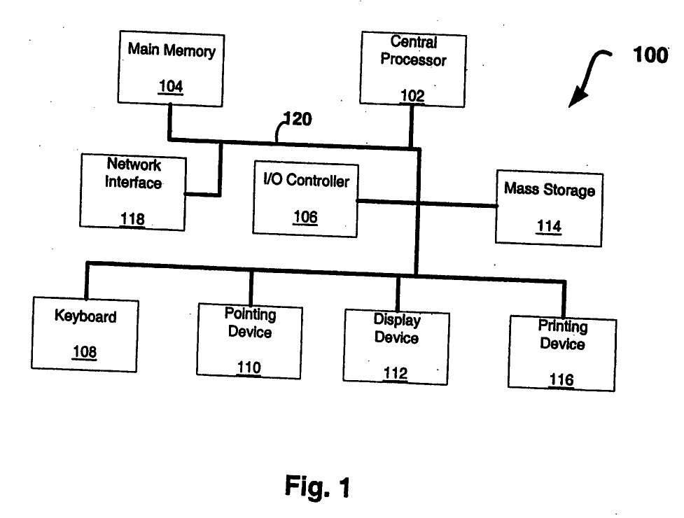

Looking now at the drawings, FIG. 1 shows the basic format where the Video Presence Architecture (VPA) for the remote control of a computer may be implemented. The computer system 100 comprises a central processor 102, a main memory 104, an input/output (I/O) controller 106, a keyboard 108, a pointing device 110 (e.g. mouse, track ball, stylus, or the like), a display device 112, a mass storage 114 (e.g. hard disk, optical drive, or the like), and a network interface 118. Additional I/O devices, such as printing device 116, may be included in the computer system 100 as desired.

The system also comprises system bus 120, or a similar architecture through which the components shown communicate with each other. Additionally, those with ordinary skill in the art will recognize that computer system 100 can include an IBM-compatible personal computer utilizing an Intel microprocessor, or any other type of computer. Additionally, instead of a single processor, two or more processors can be utilized to provide faster operations.

The network interface 118 provides communication capability with other computer systems on the same local network, on a different network connected via modems and the like to the present network, or to other computers across the Internet. In various embodiments, the network interface 118 can be implemented in Ethernet, Fast Ethernet, Gigabit Ethernet, wide-area network (WAN), leased line (such as T1, T3, optical carrier 3 (OC3) and the like, digital subscriber line (DSL and its varieties, such as high bit-rate DSL (HDSL), integrated services digital network DSL (IDSL) and the like, time division multiplexing (TDM), asynchronous transfer mode (ATM), satellite, cable modem, Universal Serial Bus (USB) and FireWire.

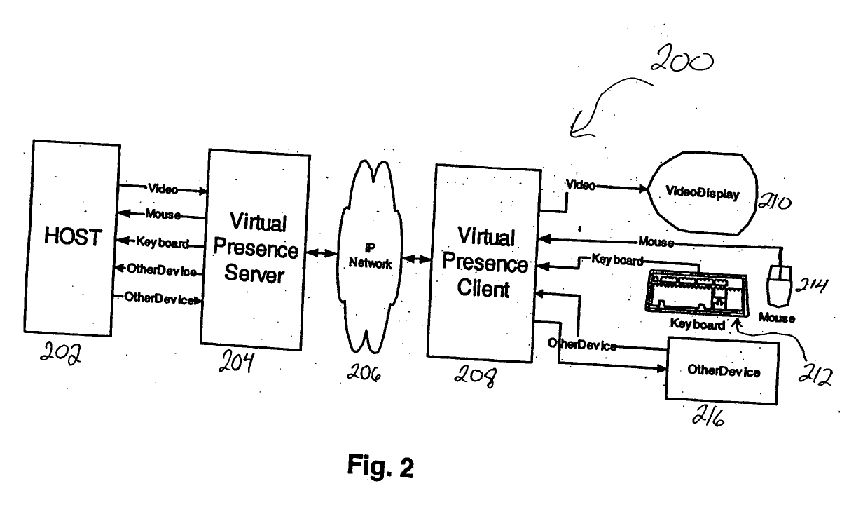

FIG. 2 illustrates an exemplary block diagram of a Virtual Presence Architecture (VPA) in accordance with an embodiment of the present invention.

Table 1 below provides a glossary of the terms used to describe the VPA architecture in accordance with some embodiments of the present invention (such as those discussed with respect to Figs. herein).

TABLE 1
Glossary of Terms

| TERM | GLOSSARY |
|---|---|
| Capture | The process of digitizing and formatting data for processing. |
| Decode | Decode: the process of converting data encoded, e.g., by a |
| | virtual presence encoder for a device into a form suitable for |
| | transfer to that device. |
| Encode | The process of converting signals captured for a device into |
| | a form suitable for transfer to, e.g. a virtual presence |
| | decoder. |
| Host | The remote computer that is to be controlled form the local |
| | client. |
| NIC | Network interface connection, i.e., the device that provides |
| | network connectivity. |
| VPC | Virtual presence client; the subsystem that captures |
| | keyboard, mouse and other local device inputs for |
| | transmission to the VPS, and decodes the video display and |
| | other outputs from the VPS |
| VPP | Virtual presence protocol; the syntax and semantics of the |
| | messages exchanged by the VPS and the VPC. The VPP |
| | may be implemented on transmission control protocol |
| | (TCP) and user datagram protocol (UDP) over IP in an |
| | embodiment of the present invention |
| VPS | Virtual presence server; the subsystem that captures the |
| | hardware outputs of the host, encodes them for transmission |
| | to the VPC, and decodes the keyboard, mouse and other |
| | device inputs transmitted by the VPC. |
| Message Multiplexer | The entity that receives messages and tags them as being a |
| | particular type, then delivers them to be compressed and |
| | optionally encrypted. |
| Message Demultiplexer | The entity that takes decrypted and decompressed data from |
| | the stream and delivers it to the receiver registered to get |
| | that message type. |
| Frame Buffer | Memory where the digital image of the screen is stored; in |
| | an embodiment of the present invention, it consists of 16 bit |
| | pixels with 5 bits each for Red, Green and Blue intensity. |
| Tile | 256 pixel area of the frame buffer treated as a unity by the |
| | video subsystem in accordance with an embodiment of the |
| | present invention. |

In FIG. 2, the VPA 200 includes a Virtual Presence Server (VPS) 204 co-located with the remote host 202 and a Virtual Presence Client (VPC) 208 at a location remote from the VPS. The host 202 interacts with the devices connected to the VPC (such as video display 210, keyboard 212, mouse 214, and other device 216) as if they were connected directly to host 202. In one embodiment of the present invention, an advantage of this approach is the flexibility in the design and deployment of the VPS 204.

FIG. 2 further demonstrates that keyboard 212, mouse 214, other device 216 send their respective signals to the VPC 208. VPC 208 captures the hardware outputs of the host and encodes them for transmission to the VPS 204. The transmission to the VPS 204 can take place over IP Network 206, which is connected to host computer 202. Following transmission, the signals arrive in VPS 204, which decodes the keyboard 212, mouse 214 and other device 216 inputs transmitted by the VPC 208. These inputs are then sent to the host computer 202, where the input commands are executed. Following the execution of the keyboard, mouse and other device commands, host 202 sends a hardware output in the form of a video signal displaying changes resulting from the input commands and a signal for the other device 216. The VPS 204 captures the hardware outputs and encodes them for transmission to the VPC 208 over IP Network 206. VPC 208 then decodes the video and other device outputs from the VPS and transmits them to either video display 210 or other device 216.

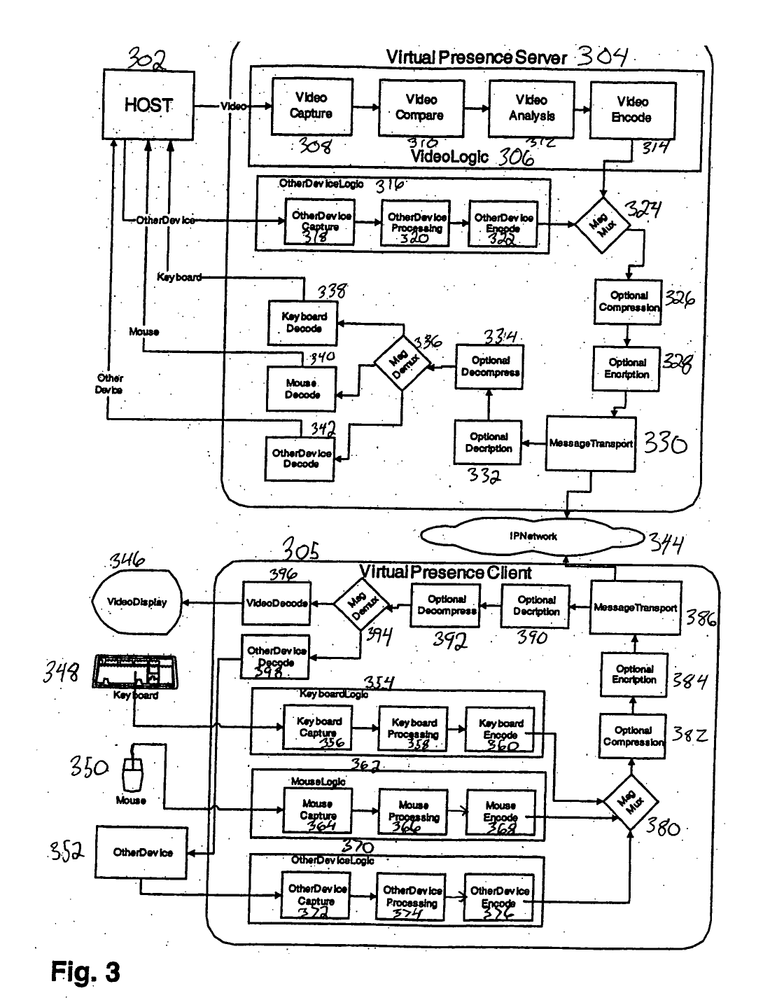

FIG. 3 illustrates a more detailed block diagram of a VPA in accordance with another embodiment of the present invention. Here, VPC 305 accepts signals from keyboard 348, mouse 350, and other device 352. These signals are then input to Keyboard Logic 354, Mouse Logic 362, and Other Device Logic 370, respectively. Inside each of the logic devices, the respective signals are captured at steps 356, 364, and 372, respectively, and are digitized and formatted for processing at steps 358, 366, and 374, respectively. After processing, the signals are encoded at steps 360, 368, and 376, respectively, by converting the captured signals for each device into forms suitable for transfer to a decoder, such as a Virtual Presence decoder. After the signals are encoded, they are sent to multiplexer 380, which combines the keyboard, mouse and other device signals in preparation for transmission to the VPS 304. However, before transmission, the signals can optionally be compressed in step 382 and/or encrypted in step 384. Then the signals are transported in 386 via IP network 344 to the VPS 304.

Once in VPS 304, the signals are decrypted and decompressed in items 332 and 334, respectively, if necessary. The input signals are then demultiplexed in 336 in order to separate the signals for decoding individual keyboard, mouse and other device signals in items 338, 340, and 342, respectively. Then the keyboard, mouse and other device signals are sent to the host 302, where the commands are executed internally. Following the execution of the keyboard, mouse and other device inputs, two hardware output signals are transmitted back to VPS 302, the video output signal and the other device output signal. The video output signal enters Video Logic element 306, which captures, compares, analyzes and encodes the output in steps 308-314, respectively. The other device output signal is sent to Other Device Logic element 316, where it is captured, processed and encoded in steps 318-322, respectively. The encoded video and other device outputs are then multiplexed in step 324, and can optionally be compressed and/or encrypted in steps 326 and 328, respectively.

The multiplexed output signal is then transported in step 330 over IP Network 344 to the VPC 305. Once the output signal is back in the VPC, it is decrypted and decompressed, if necessary, in steps 390 and 392, respectively. The output signal is then demultiplexed into separate video and other device signals in step 394. Following that, the two signals are decoded in steps 396 and 398, and then sent to video display 346 and other device 352, where the outputs are displayed to the remote user. For example, the video output signal of host 302 is displayed on video display 346, and the other device output signal is executed on other device 352.

In another embodiment of the present invention, the devices in the VPA can be characterized by their data flow requirements. For example, the video logic system 306 on the VPS captures video frames, does delta analysis to compare current frame data to that of an earlier frame, and encodes the stream for the VPC to decode and display. This does not require any return information in accordance with an embodiment of the present invention. Similarly, the mouse and keyboard subsystems may simply transmit the stream from their corresponding devices on the VPC 305 for transmission to the VPS 304. On the other hand, special devices such as a USB may require bi-directional transfer, which are treated as independent directional flows by the architecture.

In a further embodiment of the present invention, the VPS 304 captures video and transmits it to the VPC 305. For example, the VPS 304 receives the mouse and keyboard data streams from the VPC 305 and decodes them into signals for the Host 302. The VPS 304 manages input and output data streams for other devices and simulates the local interactions necessary to provide remote functionality.

In accordance with another embodiment of the present invention, the keyboard, mouse and other device signals may all be simple byte streams. Therefore, there would be little processing necessary to decode the streams. However, there is significant processing necessary to maintain synchronization and duplicate the semantics and timing of the streams so that the Host can properly maintain its states as if the devices were directly connected.

More specifically, the VPS 304 keyboard subsystem relays the byte stream from the remote keyboard 348 to the Host 302 without any additional processing. In a further embodiment, the VPS 304 mouse subsystem relays the byte stream from the remote mouse to the Host 302. This byte stream may include delta messages (e.g. signals indicating change), which are interpreted by the Host 302 relative to the current position of the cursor. Due to timing and other issues, the relative position of the cursor can get out of sync with the actual position of the cursor. Consequently, special processing in both the VPS 304 and VPC 305 can be used to mitigate this problem.

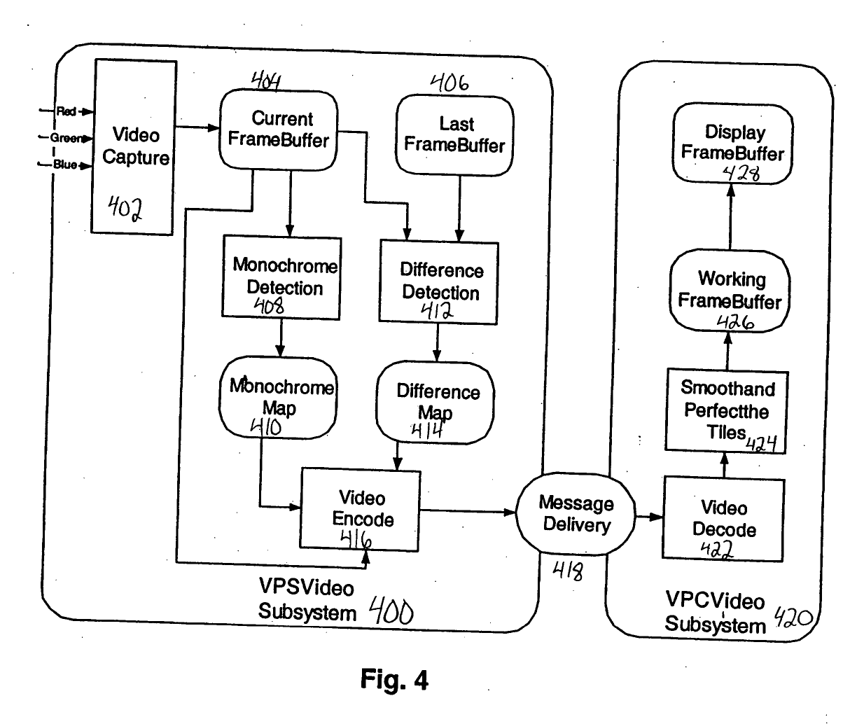

FIG. 4 illustrates an exemplary block diagram of a VPS inside a host computer with external loop back cables in accordance with an embodiment of the present invention. As discussed herein, implementations of the VPA may be done with various configurations of hardware and software. The loop back configuration of FIG. 4 is envisioned to provide several advantages.

Therefore, the loop back configuration described here puts the PCI card functions on an FPGA, which may be used to implement the logic in hardware. Then, a cable is connected into the PCI card functions from the internal video graphics card. This effectively puts the PCI card into the host computer, but it does not affect the way that the host CPU is running. Therefore, the PCI card uses a slot and power from the host computer, but does not affect its performance or functioning in any way. However, this placement allows the PCI card to capture the video signals coming from the host computer and relay them across the network. Additionally, the PCI card has the functionality to receive keyboard and mouse strokes and relay them to the keyboard and mouse ports on the host.

Additionally, in the loop back configuration, there are no video, keyboard or mouse drivers attached to the host from the VPS. Also, there is no impact on the host except for power, ground and slot consumption (e.g., a PCI slot). Further, no platform certification issues exist because it does not interact with the PC bus. Therefore, the VPA will function with any commercially available personal computer. Moreover, this system is relatively simple to install and there is no impact on the local operator of the Host.

As shown in FIG. 4, the Host 402 is in communication with Virtual Presence Server (VPS) 404. VPS 404 receives keyboard 410 inputs, mouse 412 inputs and other device 414 inputs via IP network 406. The VPS 404 receives these signals through their previously described respective subsystems, and sends them to Host 402. It should be noted that there is not a virtual presence client (VPC) pictured in FIG. 4 because it is embodied entirely in software on the remote computer or terminal emulator. Once inside Host 402, the signals are executed internally. Host 402 then outputs video and other device signals, which are transmitted to video display 408 and other device 414 by VPS 404 over IP network 406 for execution on those devices.

In an embodiment of the present invention, a PCI card may be utilized as VPS 404. The PCI card would use only the power and ground for the PCI card slot on the host computer 402. The PCI card has a connector that accepts the video, keyboard and mouse data of the client computer and provides connections for the corresponding devices to be connected and looped through to the host. In addition, it has an external power connection so that the VPS on the card can monitor power status of the host.

It is envisioned that other devices may be remotely connected to the host using a similar architecture as the PCI architecture. For example, a USB device, which provides a serial connection to deliver a stream of bytes between two entities, may be used. It has certain timing and signaling characteristics that are required for its function. Since USB is bi-directional, a complete encode and decode subsystem may be implemented for both VPS and VPC.

Moreover, the VPS may implement the logic necessary to emulate the USB device for the Host. The VPC may then implement the logic necessary to emulate the Host for the USB device. This may require buffering of the byte stream on both ends and emulating the timing characteristics required. This may also require special processing similar to the video subsystem, depending on the particular device. In particular, new digital display devices are replacing traditional cathode ray tubes (CRTs) in many applications and are connected using USB technology.

In another embodiment of the present invention, the VPC encodes the byte stream from the local keyboard and delivers it to the message subsystem, which in turn optionally compresses and encrypts the stream. The stream is then transmitted to the VPS. Keyboard processing is envisioned to be a simple direct transfer with no feedback between the VPS and the VPC software in accordance with an embodiment of the present invention.

In a further embodiment of the present invention, the VPC encodes the byte stream from the local mouse and delivers it to the message subsystem, which in turn optionally compresses and encrypts the stream, and then delivers it to the VPS. The encoding consists of aggregating mouse move messages and transmitting them. Additional processing may be performed by the mouse subsystem to keep the cursors synchronized.

In another embodiment of the present invention, the VPC receives an encoded video stream from the VPS. The VPC decodes the stream into a working buffer, which it then processes to remove artifacts of the encoding algorithm used. Then, the working buffer is transmitted to the actual display buffer on the VPC, which the video hardware displays on the local display device.

It is envisioned that the architecture discussed herein may be implemented in many different ways. In various embodiments of the present invention, the Virtual Presence Architecture may be implemented utilizing one or more of the following techniques:

use a heavily pipelined application specific integrated circuit (ASIC) or FPGA to create the Tile Map and the Monochrome Map;

when compressing and sending large data blocks, split them up so they overlap (for example: compress a little, send a little);

use DIB Section API's on windows, or DirectX;

find the extents of the changed area and only send update info for that area;

client may start request for next update area before it processes current area, or server may automatically prepare next update area;

if more than one Monochrome or No Change tile are present in the video encoder, stack them together and send;

overlap as many operations as possible that can happen in parallel;

when painting the mono tile on the client, blend its edges with surrounding area;

for slower links such as Dial-up or DSL, the packet turn around time can be relatively long, so one can modify any transport used to send long streams of packets and not spend time waiting for acknowledgements;

pick a compression function that is balanced in time with the transport time (for example, one may avoid spending more time compressing than the bandwidth of the transport may easily handle);

tune client code to native OS and CPU for best performance;

for very slow transports, spend extra time to break up tiles into subsections, and reduce data (e.g., blend groups or pixels into one, or reduce to 8-bit color instead of 32-bit color, and the like).

The foregoing description has been directed to specific embodiments of the present invention. It will be apparent to those with ordinary skill in the art that modifications may be made to the described embodiments of the present invention, with the attainment of all or some of the advantages. For example, the techniques of the present invention may be utilized for provision of remote situations, gaming and the like. Therefore, the object of the appended claims to cover all such variations and modifications as come within the spirit and scope of the invention.

1. A virtual presence architecture (VPA) between a host computer and a remote computer comprising:
a virtual presence server installed inside said host computer and utilizing electronically only said host computer's power source; and
a virtual presence client communicating with said host computer through said virtual presence server to provide a virtual presence on said remote computer.

2. The VPA of claim 1, wherein said virtual presence server is a PCI card installed in a PCI slot of said host computer.

3. The VPA of claim 1, wherein said virtual presence server includes a connector that connects to a video graphics card, keyboard and mouse of said host and provides connections for the corresponding devices to be connected and looped through to said host.

4. The VPA of claim 1, wherein said virtual presence server includes an external power connection so that it can monitor the power status of said host.

5. The VPA of claim 1, wherein said virtual presence server uses only power, ground, and a physical PCI slot of the host computer.

6. The VPA of claim 1, wherein said virtual presence server does not interfere with the processing of said host CPU.

7. A virtual presence architecture (VPA) comprising:
a host computer;
means for establishing a virtual presence server installed inside said host; and
means for establishing a virtual presence client communicating with said host computer to provide a virtual presence solution.

8. A method of providing virtual presence, comprising:
identifying a host computer;
identifying a remote computer;
installing a virtual presence server (VPS) in said host computer;
installing a virtual presence client (VPC) in said remote computer; and
sending data between said host computer and said client computer in order to establish a virtual presence on said host computer.

9. The method of claim 8, further wherein the VPS is a PCI card installed in the host computer.

10. The method of claim 9, wherein the VPS uses only power, ground, and a PCI slot of the host computer.

11. The method of claim 8, wherein the VPS connects to a video graphics card, keyboard and mouse of the host and provides connections for the corresponding devices to be connected and looped through to the host.

12. The method of claim 8, wherein the VPC is implemented entirely in software installed on said remote computer.
